(19) United States
(12) Patent Application Publication
(10) Pub. No.: US 2004/0064458 A1
(43) Pub. Date: Apr. 1, 2004

(54) Deletion objector for determining whether or not to delete an object from an application

(76) Inventor: Richard Hagarty, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/260,273

(22) Filed: Oct. 1, 2002

(51) Int. Cl. G06F 7/00

(52) U.S. Cl. 707/100

(57) ABSTRACT

A value-add software component of an application registers as a deletion objector in order to help determine whether or not to delete an object from an object database in the application. A user interface (UI) component in the application receives a request from the user to delete one or more selected objects from the database, and notifies the deletion objector of the received deletion request. In response, the deletion objector notifies the UI component whether or not the selected objects should be deleted based on any dependencies the deletion objector has built on the selected object(s) in the deletion request. The deletion objector's response to the deletion request may indicate either that the selected objects should be deleted, the selected objects should not be deleted, or that the user should be warned of certain consequences before the selected objects are deleted.

### BACKGROUND OF THE INVENTION

A software framework is a platform, which can support an application whose functionality extends across a family of related problems. Such applications can be generated by integrating different software components, each capable of solving a particular problem. For example, an application directed to the management of a storage area network (SAN) may integrate the functionality of a storage allocation component for controlling access to storage devices in the SAN, a storage optimization component for monitoring performance of the entire SAN, and a storage accounting component for measuring storage space assigned to end users of the SAN. Such software components can be referred to as value-add components, because they each add value, i.e., some type of functionality, to the application.

An application may be built with future expansion of functionality in mind. In other words, the software framework may allow “plug-in” value-add components to be integrated in the application after deployment. Such plug-in value-add components may be developed by different software providers than the application.

An application may maintain a database of objects, upon which the value-add components may build dependencies. The application may further include a user interface to allow a user to request deletion of objects in the database. However, the deletion of a database object may cause a data integrity issue to arise in a value-add component, which has built a dependency on the object. Accordingly, the value-add component may not function properly as a result of the deletion.

Because plug-in value-add components may be developed independently by different software providers, the application may not know the value-add components' dependencies, and therefore cannot determine which database objects will cause data integrity issues when deleted.

“Uninstaller” components have been developed for operating systems such as Windows® to monitor the installation of software components. An uninstaller component maintains a registry, or database, keeping track of the new files installed in the system. The registry also records any dependencies subsequently built on these files by other applications and components. When a user chooses to remove a certain software component, the uninstaller will warn the user of files whose deletion may affect the operation of other applications and components, based on these dependencies. However, the maintenance of a central registry requires a significant amount of processing as the number of software components installed in the system increases.

### SUMMARY OF THE INVENTION

An embodiment of the invention is directed to a software framework on a computer readable medium, execution of which causes one or more processors to determine whether or not to delete a resource object from an application, the software framework comprising: a user interface (UI) component to receive a deletion request to delete one or more objects maintained by the application, and to relay the deletion request to deletion objectors; and one or more value-add components, registered with the UI component as deletion objectors, operable to respond to the requested deletion of one or more resource objects.

Other advantages and features of the invention will become more apparent from the detailed description hereafter. However, it should be understood that the detailed description and specific examples, while indicating preferred embodiments of the invention, are given by way of illustration only, since various changes in modifications within the spirit and scope of the invention will become apparent to those skilled in the art from this detailed description.

### BRIEF DESCRIPTION OF THE DRAWINGS

The invention will become more fully understood from the detailed description and the accompanying drawings, wherein:

FIG. 1 is a functional block diagram of an application according to an embodiment of the invention.

FIG. 2 is a sequence diagram illustrating the process by which a deletion objector allows a user's deletion request to be carried out, according to an embodiment of the invention.

FIG. 3 is a sequence diagram illustrating the process by which a deletion objector provides a warning in response to a user's deletion request, according to an embodiment of the invention.

FIG. 4 is a sequence diagram illustrating the process by which a deletion objector prevents a user's deletion request from being carried out, according to an embodiment of the invention.

FIG. 5 is a sequence diagram illustrating the process by which one of a plurality of deletion objectors prevents a user's deletion request from being carried out, according to an embodiment of the invention.

FIG. 6 is a sequence diagram illustrating the process by which a user's deletion request is confirmed after a plurality of deletion objectors provide warnings, according to an embodiment of the invention.

FIG. 7 is a sequence diagram illustrating the process by which a user's deletion request is canceled after a plurality of deletion objectors provide warnings, according to an embodiment of the invention.

### DETAILED DESCRIPTION OF THE EXEMPLARY EMBODIMENTS

The following description of exemplary embodiments of the invention is merely illustrative in nature, and is in no way intended to limit the invention, its application, or uses.

An embodiment of the invention is described as a software framework, which provides a platform for building object-based applications. The software framework allows independent “plug-in” software components, i.e., value-add components, to be integrated together with a user interface component (UI) component into a single application, which maintains an object database. The UI component provides a user interface to allow a user to input a request to delete certain objects from the object database.

However, some of the value-add components may have built a dependency on the objects selected by the user for deletion. Accordingly, deletion of the objects may cause data integrity issues to arise in these value-add components. To avoid such problems, a value-add component can help determine whether or not to delete certain types of database objects by registering as a “deletion objector.” While registering as a deletion objector, a value-add component may indicate that it is interested in one or more (or possibly all) types of objects in the database. In an exemplary embodiment, a value-add component may be registered as a deletion objector by a registration component in the UI component.

When the user inputs a request to delete one or more objects via the user interface, the UI component notifies each deletion objector interested in the corresponding object type(s). For example, the UI component may relay the deletion request to each interested deletion objector, or send another type of message identifying the objects in the deletion request. In response, each notified deletion objector determines whether or not the identified objects should be deleted based on dependencies the deletion objector may have built on these objects. Then, the deletion objector sends to the UI component one of the following types of replies: the objects can be deleted; the objects should not be deleted; or the user should be warned of the consequences of deleting the objects before the request is executed.

While an embodiment of the invention will be described in conjunction with storage management applications for storage area networks (SANs), skilled artisans will appreciate that other embodiments of the invention are not limited to SANs. The software framework meets the specific needs of both Storage Node Manager (SNM) and Storage Area Manager (SAM) products that are available from the HEWLETT PACKARD CO. However, the software framework does not require SNM and SAM components to be present. In other words, they are not necessarily a core part of the UI framework.

An embodiment of the invention provides a software framework that builds upon functionality provided by a Java Core framework (JCore). JCore is a Java class library that facilitates the development of distributed applications. JCore provides a standard framework for the development of application functionality that is “plugged-in” to a distributed application. JCore facilitates construction of application features as modular components (e.g., the UI component and value-add components) that can be quickly packaged together. Furthermore, client applications can be automatically updated with new or enhanced components without user intervention. Using JCore, individual components can be added to and removed from applications easily with no coding impact on other components.

Another benefit of JCore includes an automatic component update feature for the client application. According to the aforementioned features of JCore, the software framework can support a distributed application including a dynamic number of value-add components, by allowing value-add components to be added, removed, or otherwise updated without interrupting the operation of the application. The JCore classes are described in more detail below.

According to an alternative exemplary embodiment, the software framework may rely on Java-based technologies other than JCore to build and integrate the components of the application. For example, Jini™ technology, developed by Sun® Microsystems, also provides an architecture for developing distributed applications, in which components can be added and removed without interrupting services provided by the application.

### Software Framework

An embodiment of the invention will be described in conjunction with an exemplary implementation that relates to a storage area network (SAN). Various components can be organized into an application that serves as a Storage Area Manager (SAM) platform to manage and control access to the individual storage devices within the SAN. Skilled artisans will appreciate that the following description is an exemplary implementation for a specific product deployment using the software framework. Some of the components that are identified below are not part of the software framework.

The term “resource objects” will be used in the remainder of this application to refer to the database objects that the user may request to delete via the user interface. Accordingly, the database in which the resource objects reside will be referred to as a “resource object database.” Such terminology is used to distinguish the resource objects and resource database from any other type of objects and databases that may be employed in the software framework, application, or various application components.

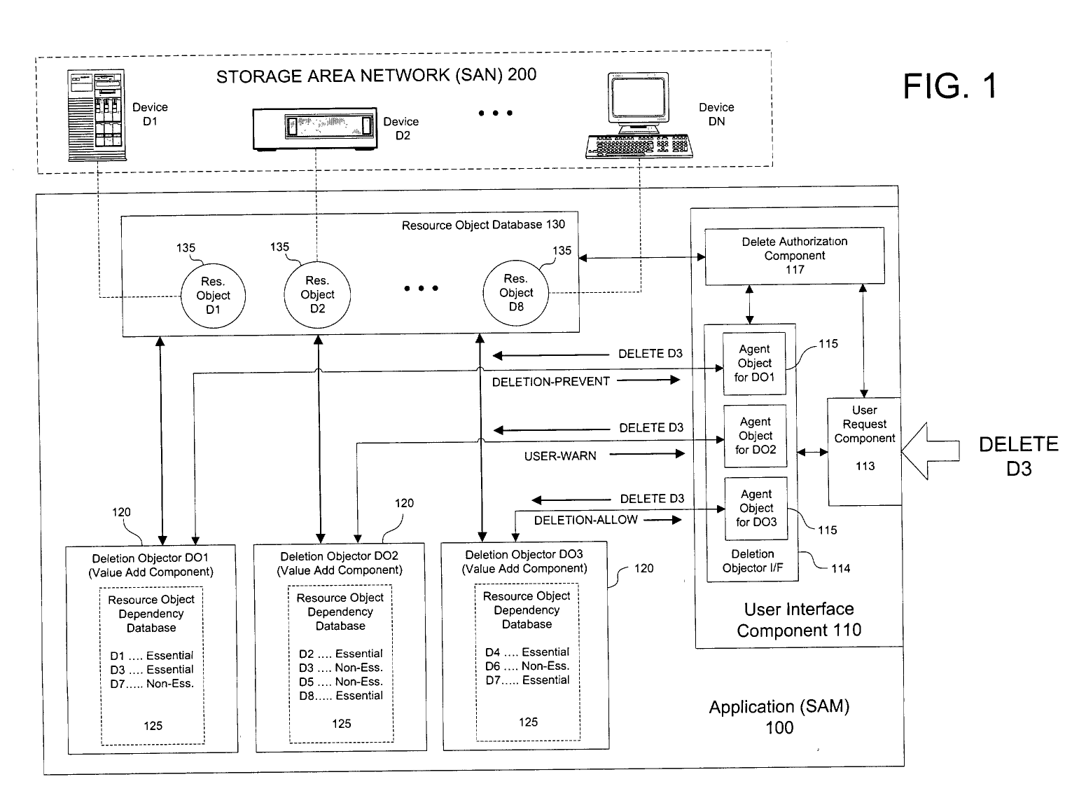

Referring now to FIG. 1, a client application 100 is part of the software framework. The application 100 includes a UI component 10, a resource object database 130, and value-add components registered as deletion objectors 120. The resource object database 130 includes a plurality of resource objects 135, each corresponding to a certain storage device D1 . . . DN in a storage area network 200.

The application 100 can be loaded and run on a host. For example, the host can be a computer (including a CPU, input device(s), output device(s), non-volatile memory, and volatile memory) connected to the network.

In FIG. 1, three value-add components of the application 100 are shown, each having registered with the UI component 110 as deletion objectors 120 interested in the same type of resource object 135, i.e., resource objects 135 corresponding to devices D1 . . . D8 in the SAN 200. The deletion objectors 120 are labeled as DO1, DO2, and DO3, respectively. Although these deletion objectors 120 are described as being interested in device-type resource objects 135, they may also be interested in other types of resource objects (not shown in FIG. 1) residing in the resource object database 130.

While FIG. 1 only shows three deletion objectors 120, FIG. 1 is provided for the purpose of illustration, and in no way limits the number of deletion objectors 120, or any other aspect of the application 100 or software framework. For instance, the application 100 of FIG. 1 may also include other value-add components 120, which are not registered as deletion objectors 120. Further, the application 100 may include various other deletion objectors 120, which are only interested in different types of resource objects 135.

The UI component 110 includes an interface 114 to each deletion objector 120. In the exemplary embodiment of FIG. 1, this interface 114 includes a set of agent objects 115, each corresponding to a different one of the deletion objectors 120. As shown in FIG. 1, one of the agent objects 115 corresponds to deletion objector DO1, another agent object 115 corresponds to deletion objector DO2, and a third agent object 115 corresponds to deletion objector DO3. Each of the agent objects 115 is used to relay a user's deletion request to the corresponding deletion objector 120.

As mentioned above, elements D1 . . . DN represent devices connected to the SAN 200. When the application is directed to storage area management (i.e., when the application 100 is a SAM), each resource object 135 may correspond to one of the devices D1 . . . DN in the SAN 200. However, the resource objects 135 are not limited to representing devices in the SAN 200. A resource object 135 may also refer to a group of devices, a logical unit number (LUN), a user group authorized to access a certain LUN or device, or any other manageable entity in the SAN 200 (e.g. user groups, groups of devices, sub-devices, host bus adapters (HBAs), ports, etc.).

Furthermore, different types of resource objects 135 may be defined for different types of devices connected to a SAN 200. For example, a deletion objector 120 in application 100 may be allowed to register separately for host devices, user workstation devices, disk storage devices, etc.

### UI Component

In one embodiment, the component 10 of the software framework provides a graphical user interface (GUI) (not depicted) for the base application 100, and a set of common GUI services. The GUI services may include navigation, general configuration, toolbars, menu bars, help, and other GUI functionality. It can be that the UI component 10 does not provide any functionality specific to storage management in a SAM application 200.

The UI component 10 may provide the user a browser-style window with a navigation tree for displaying the resource objects 135 stored in the resource object database 130. The navigation tree may also display the contents of the current resource object 135 selected in the tree. An additional log panel may be provided for displaying events associated with the selected resource object 135. The browser paradigm was chosen for the base application for the because it can be adapted to display a diverse range of information. Browser-style Windows, such as those employed in Windows® and Explorer®, are widely used and well understood. Alternatively, the UI component 110 may provide a command line type of interface to the user.

As mentioned above, one of the basic services provided by the UI component 110 is navigation of items selected by the user. Visual components such as a navigation tree, navigation controls, and view panel areas may be employed to handle navigation. The UI component 110 can maintain one or more hierarchies of resource objects 135 in the resource object database 130.

As mentioned above, resource objects 135 can be organized hierarchically and presented in a navigation tree component. There can be multiple resource object trees in the application 100, each representing a separate context for displaying the contents of the resource object database 130. For example, SAN devices and entities can be presented in a topology context, where each node in the tree represents a smaller group in the topology. Another context could present the same devices in an “inventory” hierarchy, where folders represent groups of similar objects such as host, switches, etc. The GUI may allow the user to select a context, e.g., with the navigation context tabs in the navigation tree panel.

The UI component 110 allows the user to execute certain management functions with respect to the resource object database 130 in the application 100, including the selection and deletion of resource objects 135. For example, using a GUI browser window, the user may generate a deletion request to delete one or more resource objects 135 by manipulating visual components (icons) using one or more input devices. A user request component 113 in the UI component 110 processes such manipulations to determined the user's deletion request.

For example, the user may generate a deletion request by highlighting icons in the browser-window representing resource objects 135 using a mouse (or some other type of pointing device), and then clicking on (or activating) the delete button on a toolbar. The user request component 113 would then process these user actions to determine which resource objects 135 the user wishes to delete.

However, one or more value-add components 120 may have built a dependency on the resource object(s) 135 selected by the user for deletion. In such a case, deleting the selected resource object(s) 135 may cause these value-add components not to perform their functions in the application 100 properly.

Accordingly, for each value-add component 120 registered as a deletion objector, an agent object 115 is generated in the UI component 110 as shown in FIG. 1. The agent object 115 allows a deletion objector 120 to notify the UI component 110 of any dependencies built on the selected resource objects 135.

An agent object 115 can be defined as an interface to the UI component 110 for any object or component interested in potential changes to the resource object database 130. Such components indicate their interest by registering with the UI component 110. While an embodiment of the invention is described with respect to value-add components interested in potential deletions to certain types of resource objects 135 in the resource object database 130, an agent object 115 may also be used to alert a value-add component (or any other type of component) of the addition of new resource objects 135, or any other events affecting the resource object database 130.

In an exemplary embodiment, each agent object 115 receives the deletion request from the user request component 113, and relays the deletion request to the corresponding deletion objector 120. In an alternative embodiment, after receiving the deletion request, each agent object 115 may generate a new message identifying the resource object(s) 135 selected by the user for deletion, and send this message to the corresponding deletion objector 120.

FIG. 1 shows an example where the user inputs a deletion request DELETE D3 to delete the resource object 135 corresponding to device D3 in the SAN 200. Accordingly, each of the agent objects 115 relays the deletion request DELETE D3 to a corresponding one of the deletion objectors DO1, DO2, and DO3 (or sends an equivalent notification). Each agent object 115 then “listens” for a reply message, or other type of response, from its respective deletion objector 120. In one embodiment, each agent object 115 directly calls a callback function of the corresponding deletion objector 120. The deletion objector 120 then responds by sending a return code via the callback.

Based on the responses that the agent objects 115 of FIG. 1 receive from the deletion objectors DO1, DO2, and DO3, the UI component 110 determines whether or not to proceed with the user's request and delete the resource object 135 corresponding to device D3.

The UI component 110 may include a delete authorization component 117 component for determining whether or not to delete each of the selected resource objects 135 in the deletion request based on the deletion objector responses. According to an exemplary embodiment, the delete authorization component 117 acts as an interface to the resource object database 130. If, based on the responses by the deletion objectors 120, the delete authorization component 117 decides that the requested deletion of a resource object 135 should be performed, the delete authorization component 117 instructs the resource object database 130 to delete the corresponding resource object 135.

After receiving the deletion request from the corresponding agent object 115, a deletion objector 120 may respond by sending a reply message to the agent object 115. The reply message may be one of the following types: a deletion-prevent message; a user-warn message; and a deletion-allow message. A deletion-prevent message indicates that the deletion objector 120 has built a dependency on at least one of the selected resource objects 135 identified in the deletion request, such that these selected resource objects should not be deleted. Specifically, a deletion objector 120 will send a deletion-prevent message if it includes a dependency on the selected resource object(s), which is essential for the deletion objector 120 to function properly.

Alternatively, a user-warn message indicates that a dependency has been built by the deletion objector 120 on at least one of the selected resource objects 135 in the deletion request, such that the deletion of these resource objects 135 will affect the operation of the deletion objector 120. In an exemplary embodiment, the user-warn message indicates at least one consequence (e.g., how the deletion objector 120 will be affected) of deleting the selected resource objects 135. Accordingly, the UI component 110 can alert the user as to these consequences, and ask the user whether or not to proceed with the deletion request. The user can respond to this warning by either confirming that the deletion request should be executed, or canceling the deletion request.

If the deletion objector 120 has no dependency built on the resource object(s) 135 identified in a received deletion request, the deletion objector 120 will send a deletion-allow message, which indicates that the deletion request may be carried out. The delete authorization component 117 uses each reply message received in response to the deletion request to determine whether or not the resource objects 135 in the deletion request should be deleted.

To make this determination, the delete authorization component 117 classifies each received reply message as either a deletion-prevent message, a user-warn message, or a deletion-allow message. If at least one of the received reply messages is a delete-prevent message, the delete authorization component 117 determines that the deletion request should not be executed, and causes a message to be output to the user indicating that the resource object(s) in the deletion request cannot be deleted.

Alternatively, if all of the reply messages of the deletion objectors 120 are deletion-allow messages, the delete authorization component 117 can instruct the resource object database 130 to delete the resource objects 135 identified by the user in the deletion request. Accordingly, after the delete authorization component 117 confirms that the corresponding objects have been deleted from the resource object database 130, a message can be displayed to the user indicating that the deletion request has been performed.

If the reply messages received by the UI component 110 do not include any deletion-prevent messages, but includes at least one user-warn message, the delete authorization component 117 can perform a warning function. This warning function may include outputting the received user-warn messages to the user. Each user-warn message may indicate the consequences of deleting the selected resource object(s) 135.

After the user-warn messages are output, the user is prompted to respond by either canceling the deletion request or confirming it. If the user cancels the deletion request, the delete authorization component 117 does not execute the deletion request. However, if the user responds to the user-warn messages by confirming the deletion request (i.e., confirming that the resource object(s) 135 should be deleted), the delete authorization component 117 then instructs the resource object database 130 to perform the deletion request.

After the deletion request is executed, the UI component 110 displays a message to the user indicating that the selected resource object(s) 135 have been deleted.

### Deletion Objectors

According to an exemplary embodiment, a registered identifying deletion objector 120 includes a resource object dependency database 125. The resource object dependency database 125 stores records identifying resource objects 135 in the resource object database 130 on which the corresponding value-add component has built a dependency. In a further embodiment, the resource object dependency database 125 classifies these dependencies; e.g., as either essential or non-essential dependencies.

The resource object dependency database 125 allows the deletion objector 120 to determine how to respond to a deletion request. If the deletion objector 120 has an essential dependency built on a resource object 135 of a deletion request, then the deletion objector 120 responds by issuing a deletion-prevent message. On the other hand, if the deletion objector has a non-essential dependency on the resource object 135 according to the object dependency database 125, then the deletion objector 120 responds to the deletion request by issuing a user-warn message. If the resource object dependency database 125 indicates no dependency exists on the resource object 135, the deletion objector 120 can transmit a deletion-allow message in response to the deletion request.

However, the records indicating the dependencies of a deletion objector 120 may be stored in the resource object database 130. The dependencies maintained in the resource object dependency database 125 can be considered a subset of the information stored in the resource object database 130. Accordingly, some embodiments of the invention implement the resource object database 125 either as part of the resource object database 130, or as a separate database maintained within a deletion objector 120.

In an embodiment in which the resource object dependency database 125 is implemented as part of the resource object database 130, a deletion objector can access the resource object database 130 directly to determine whether a dependency exist on a resource object 135 selected in a deletion request. This alternative embodiment has the advantage of reducing the amount of overhead in a deletion objector 120 caused by maintaining a separate database.

FIG. 1 illustrates each resource object dependency database 125 in dotted lines in order to indicate that the information contained therein may be embodied as either a separate database in a deletion objector 120, or alternatively as a subset of the resource object database 130. Accordingly, any further references to a resource object database 125 in the present application refers to either a subset of the resource object database 130 storing the dependencies of a deletion objector 120, or a database of these dependencies maintained in the deletion objector 120.

Other alternative embodiments for determining the dependencies of a deletion objector 120 are also possible. For example, a deletion objector 120 may be registered for a specific type of resource object 135, such that the deletion objector 120 automatically rejects any request to delete a resource object 135 of this type. Other alternative embodiments with respect to determining the resource object dependencies of a deletion objector 120 will be readily apparent to those of ordinary skill.

In the example shown in FIG. 1, the deletion request DELETE D3 indicates that the user wishes to delete the resource object 135 corresponding to device D3. As shown in FIG. 1, deletion objector DO1 includes an essential dependency on this resource object 135 as indicated in its resource object dependency database 125. Therefore, deletion objector DO1 sends a deletion-prevent message to the UI interface 110 in response to deletion request DELETE D3. Further, deletion objector DO2 has built a non-essential dependency on the resource object 135 corresponding to device D3, as indicated in its object dependency database 125, and therefore responds to the deletion request DELETE D3 by sending a user-warn reply message. Since the object dependency database 125 of deletion objector DO3 includes no dependency on the resource object 135 corresponding to device D3, deletion objector DO3 sends a deletion-allow message to the UI interface 110 in response to the deletion request DELETE D3.

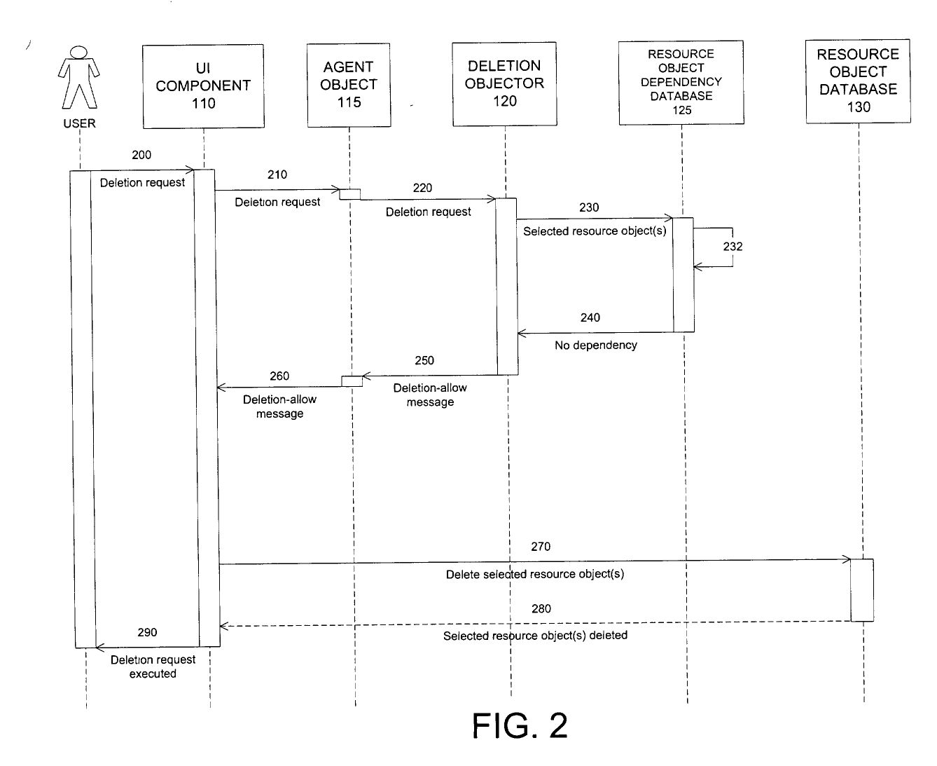

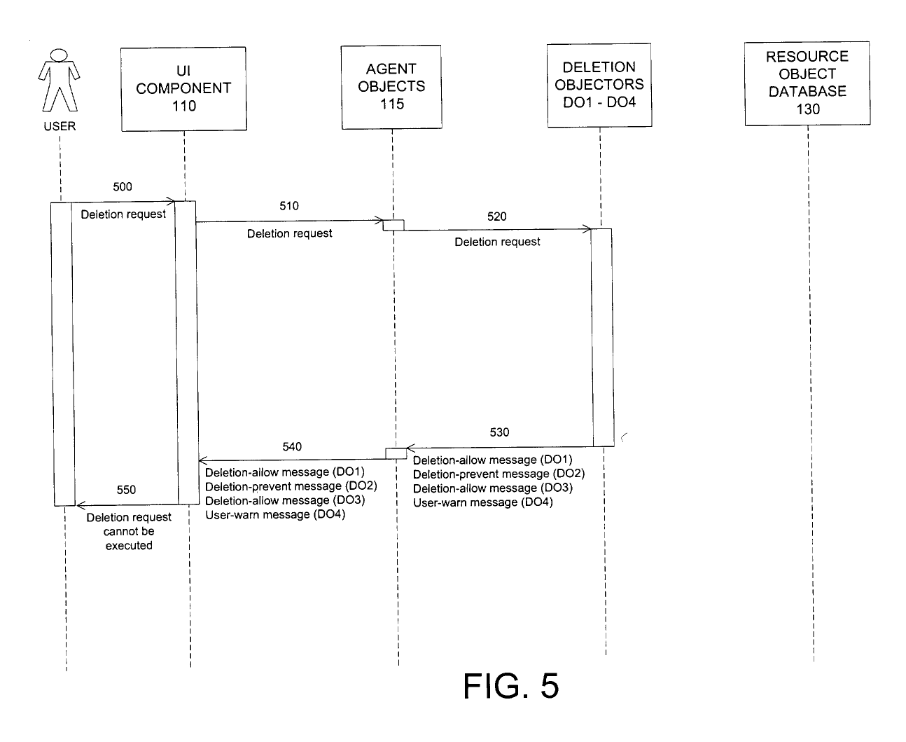

FIGS. 2-7 are sequence diagrams illustrating the operation of the various components and elements of the application 100 in response to receiving a deletion request from a user. For purposes of illustration, FIGS. 2-4 illustrate an application 100 in which only one value-add component has registered as a deletion objector 120. FIGS. 5-7 illustrate an application 100 four value-add components are registered as deletion objectors DO1, DO2, DO3, and DO4. As mentioned above, the number of registered deletion objectors 120 is in no way limited by these exemplary figures.

FIG. 2 specifically illustrates the processing of a deletion request 135 in the circumstances in which the deletion objector 120 has built no dependencies on the resource objects 135 selected for deletion. Referring to message 200, the user inputs the deletion request to the UI component 110. Messages 210 and 220 show the UI component 110 relaying the deletion request to the deletion objector 120 via the corresponding agent object 115. In message 230, the deletion objector 120 instructs the resource object dependency database 125 to perform a look up of the resource objects 135 selected for deletion. At self message 232, a look up determines whether any dependencies on these selective resource objects 135 exist.

In message 240 of FIG. 2, the resource object dependency database 125 responds to the deletion objector by indicating that no dependency exists. Messages 250 and 260 show the deletion objector 120 sending a deletion-allow message to the UI component 110 via the agent object 115. Accordingly, the UI component 110 determines that the selected resource objects 135 should be deleted, and sends an instruction to the resource object database 130 to delete the selected resource objects 135 in message 270. In message 280, the UI component 110 is notified that the resource object database 130 has deleted the resource objects 135 identified in the deletion request, and in message 290, the UI component 110 notifies the user that the deletion request has been carried out.

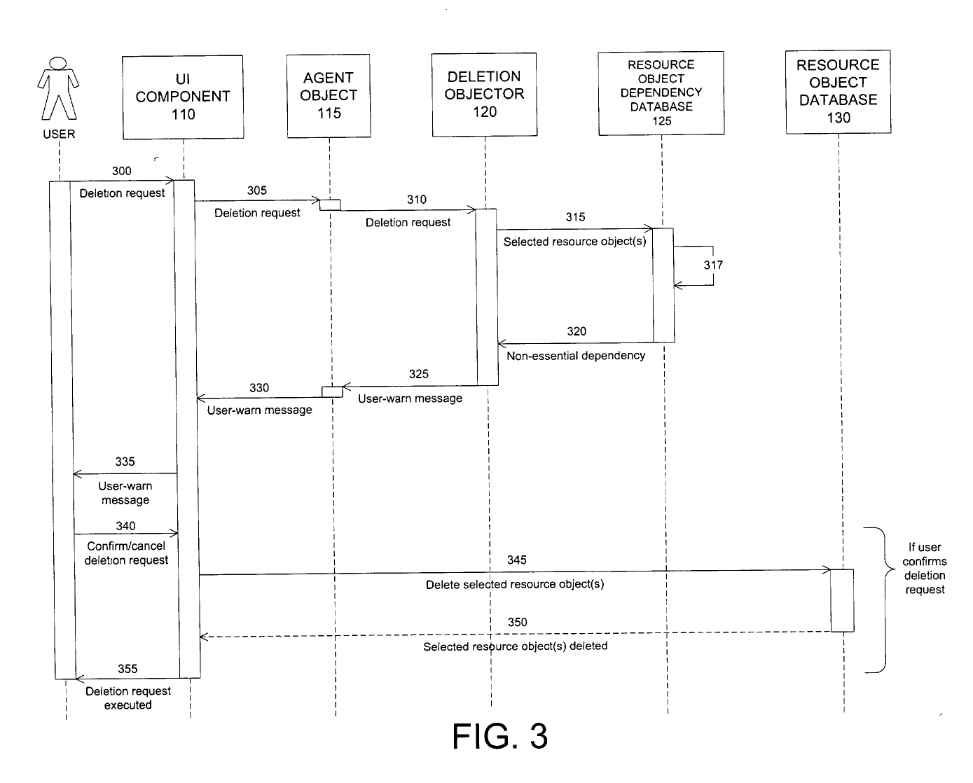

FIG. 3 is a sequence diagram illustrating a situation where the deletion objector 120 includes at least one non-essential dependency on the selected resource objects 135 in the deletion request. The user inputs the deletion request in message 300, which is relayed by the UI component to the deletion objector 120 via the corresponding agent object 115 (messages 305 and 310). In message 315, the deletion objector 120 initiates a look up in the resource object dependency database 125 for any dependencies on the selected resource objects 135. Since self message 317 determines that no essential dependencies exist in the database 125, and at least one non-essential dependency exists on the selected resource objects, the deletion objector 120 is notified of the non-essential dependency by message 320.

Therefore, the deletion objector 120 sends a user-warn message to the UI component 110 through the agent object 115, as shown by messages 325 and 330 of FIG. 3. The UI component 110 outputs the user-warn message to the user in message 335, and the user either confirms or cancels the deletion request in message 340. If the user cancels the deletion request, the UI component 110 determines that the selected resource objects 135 will not be deleted, and processing of the deletion request is terminated.

However, if the user confirms the deletion request in response to the user-warn message, the UI component 110 sends an instruction to the resource object database 130 to delete the selected resource objects 135, as indicated by message 345. After being notified that the resource objects 135 have been deleted in message 350, the UI component 110 notifies the user that the selected resource objects 135 of the deletion request have been deleted in message 355.

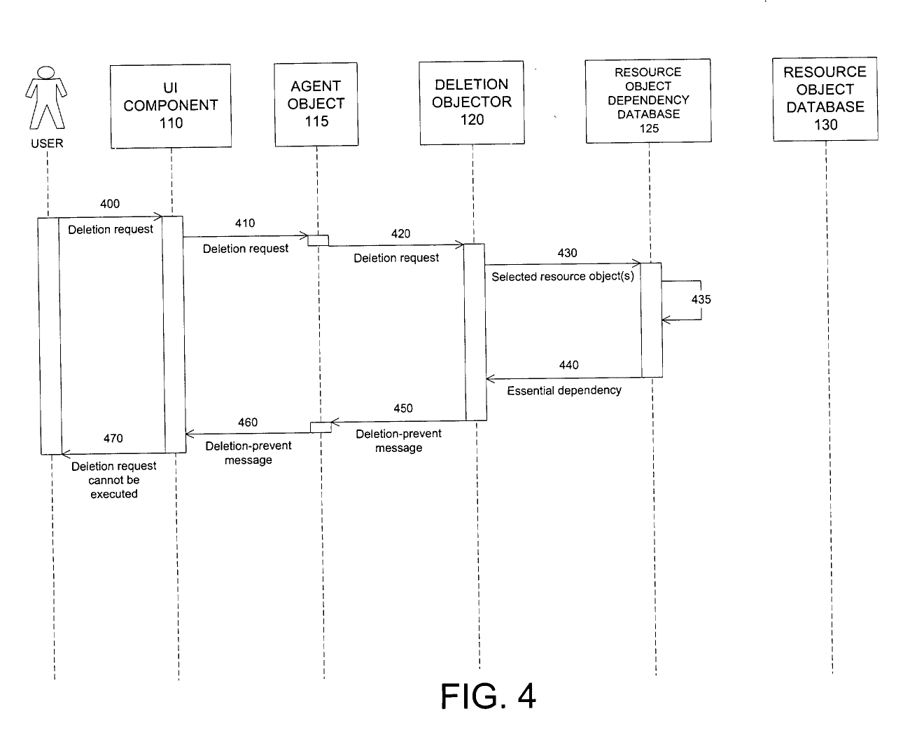

FIG. 4 is a sequence diagram illustrating an instance where the deletion objector 120 has built an essential dependency on the selected resource objects 135 of the deletion request. As shown by messages 400-420, the deletion request input by the user is relayed by the UI component 110 to the deletion objector 120 via the agent object 115. According to message 430 and self message 435, a look up is performed for the selected resource objects 135 in the resource object dependency database 125. The deletion objector 120 determines that an essential dependency exists on at least one of these objects 135 according to message 440. As a result, the deletion objector 120 sends a deletion-prevent message to the UI component 110, as indicated by messages 450 and 460. The UI component 110 notifies the user that the selected resource objects 135 in the deletion request cannot be deleted in message 470, and processing of the deletion request is terminated.

FIGS. 5-7 are sequence diagrams illustrating various situations in which four different deletion objectors DO1, DO2, DO3, and DO4 send reply messages to the UI component 110 in response to a deletion request. For the purpose of expediency, the sequence diagrams of FIGS. 5-7 do not show each of the deletion objectors DO1-DO4 performing a look up on its corresponding resource object dependency database 125.

FIG. 5 illustrates the processing of a user's request to delete one or more selected resource objects 135 when a deletion objector DO2 has built an essential dependency on at least one of the selected resource objects 135. A user inputs the deletion request to the UI component 110 In message 500. Messages 510 and 520 show the UI component 110 relaying this deletion request to the deletion objectors DO1-DO4 via their corresponding agent objects 115. After determining what dependencies exist on the selected resource objects 135, each of the deletion objectors DO1, DO2, DO3, DO4 sends a reply message to the UI component 110 based on the determined dependencies.

As shown in FIG. 5, deletion objector DO1 responds to the deletion request by sending a deletion-allow message, deletion objector DO2 sends a deletion-prevent message, deletion objector DO3 sends a deletion-allow message, and deletion objector DO4 sends a user-warn message. These reply messages are transmitted to the UI component in messages 530 and 540. At the point these messages are received and processed by the UI component 110, the delete authorization component 117 (now shown) determines that the selected resource objects 135 cannot be deleted. Accordingly, the UI component 110 notifies the user in message 550 that the deletion request cannot be executed.

In a further exemplary embodiment, after the user is notified that the resource objects 135 cannot be deleted, the UI component 110 may notify each of the deletion objectors of the status of the deletion request, i.e., whether the selected resource objects 135 have or have not been deleted, so that each deletion objective 120 can update its resource object dependency database 125. However, this further exemplary feature is not illustrated in FIG. 5.

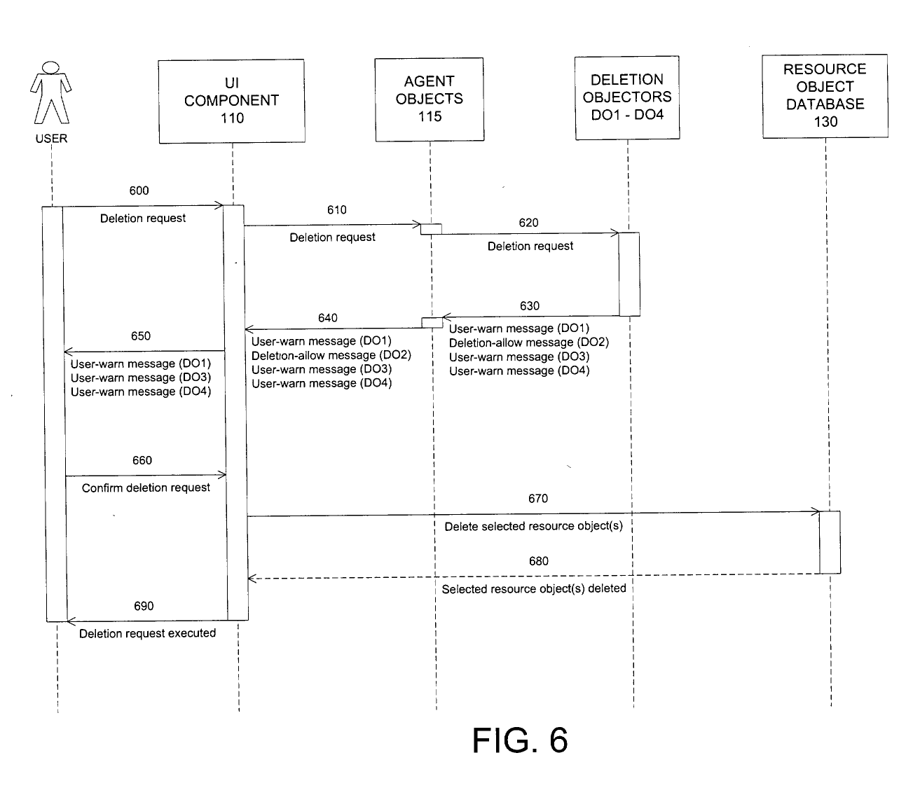

FIG. 6 illustrates a situation where the UI component 110 receives multiple user-warn messages from the deletion objectors 120. In message 600, the UI component 110 receives the user's deletion request, and this request is relayed to each of the deletion objectors DO1, DO2, DO3, DO4 in messages 610 and 620. In this case, deletion objector DO2 has built no dependency on the selected resource objects 135 in the deletion requests, while deletion objectors DO1, DO3, and DO4 have built non-essential dependencies on the selected resource objects 135. Accordingly, as shown by messages 630 and 640, deletion objector DO1 sends a user-warn message to the UI component 110, deletion objector DO2 sends a deletion-allow message, deletion objector DO3 sends a user-warn message, and deletion objector DO4 also sends a user-warn message.

Based on the reply messages received in message 640, the UI component 110 outputs each of the user-warn messages to the user in message 650 and awaits the user's response to confirm or cancel the deletion request.

In the example of FIG. 6, the user's response to these user-warn messages is a confirmation of the deletion request, as indicated by message 660. Thus, the UI component 110 makes a determination that the resource objects 135 identified in the deletion request should be deleted. After determining that the resource objects 135 in the deletion request should be deleted, the UI component 110 instructs the resource database 130 to delete the selected resource objects 135, as indicated by message 670. After being notified in message 680 that these resource objects 135 have been deleted, the UI component 110 indicates to the user in message 690 that the deletion request has been executed. The deletion objectors DO1-DO4 may also be notified of this result in a further exemplary embodiment.

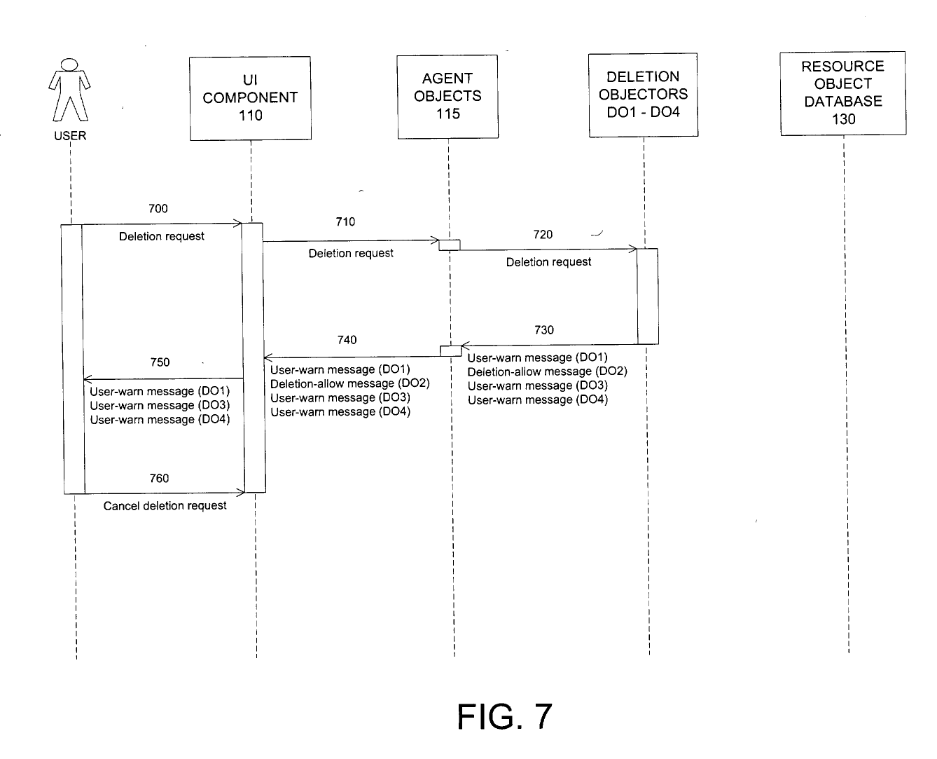

FIG. 7 is a sequence diagram illustrating a similar situation as that of FIG. 6, in which the user cancels the deletion request in response to the user-warn messages of the deletion objectors DO1-DO4. Messages 700-750 of FIG. 7 are identical to messages 600-650 of FIG. 6. However, in message 760, the user responds to the user-warn messages by canceling the deletion request. Accordingly, the UI component 110 does not carry out the deletion request, and processing terminates.

According to the above description of exemplary embodiments, a single deletion request can be made to delete more than one selected resource object 135. However, according to an alternative embodiment, the UI component 110 may generate and send a separate notification to the deletion objectors 120 for each resource object 135 selected by the user for deletion.

Furthermore, in an embodiment in which one deletion request is sent to the deletion objectors 120 to identify more than one selected resource object 135, each deletion objector 120 may respond by issuing a single reply message corresponding to all of the resource objects 135 in the deletion request (as illustrated in FIGS. 2-7). In this embodiment, each deletion objector may prevent the entire single deletion request from being executed, i.e., prevent all of the selected resource objects 135 in the deletion request from being deleted.

According to an alternative embodiment, each deletion objector 120 may generate a separate reply message for each resource object 135 in the deletion request. For example, a deletion objector 120 may receive a deletion request identifying resource objects 135 corresponding to devices D1 and D2, and respond by sending a deletion-allow message to allow the deletion of the object 135 corresponding to device D1, and sending a separate deletion-prevent message to prevent deletion of the object 135 corresponding to device D2.

The invention being thus described, it will be apparent that the same may be varied in many ways. Such variations are not to be regarded as a departure from the spirit and scope of the invention, and all such modifications as would be readily apparent to one skilled in the art are intended to be included in the scope of the following claims.

What is claimed is:

1. A software framework on a computer readable medium, execution of which causes one or more processors to determine whether or not to delete a resource object from an application, the software framework comprising:
a user interface (UI) component to receive a deletion request to delete one or more resource objects maintained by the application, and to relay the deletion request to deletion objectors; and
one or more value-add components, registered with the UI component as deletion objectors, operable to respond to the requested deletion of one or more resource objects.

2. The computer-readable software framework of claim 1, wherein the UI component provides a graphical user interface (GUI) to receive the deletion request from a user, the deletion request identifying one or more resource objects selected by the user to be deleted.

3. The computer-readable software framework of claim 1, wherein the UI component includes an agent object corresponding to each deletion objector, the agent object relaying the received deletion request to the deletion objector.

4. The computer-readable software framework of claim 3, wherein each deletion objector responds to the relayed deletion request by sending a reply message to the UI component via the corresponding interface, the UI component determining whether or not to delete the selected resource objects based on the reply messages received from the deletion objectors.

5. The computer-readable software framework of claim 4, wherein each deletion objector sends one of the following types of reply messages,
a deletion-prevent message indicating that the selected resource objects should not be deleted;
a user-warn message indicating at least one consequence of deleting the selected resource objects; and
a deletion-allow message permitting the selected resource objects to be deleted.

6. The computer-readable software framework of claim 5, wherein the selected resource objects are not deleted if the UI component receives at least one deletion-prevent message from the deletion objectors.

7. The computer-readable software framework of claim 6, wherein
the UI component performs a warning function if no deletion-prevent messages are received from the deletion objectors, and if at least one user-warn message is received from the deletion objectors; and wherein
the UI component performs the warning function by outputting each received user-warn message and prompting the user to respond to the output user-warn messages by either canceling or confirming the deletion request.

8. The computer-readable software framework of claim 7, wherein
the selected resource objects are not deleted if the user responds to the output user-warn messages by canceling the deletion request; and wherein
the selected resource objects are deleted if the user responds to the output user-warn messages by confirming the deletion request.

9. The computer-readable software framework of claim 7, wherein the selected resource objects are deleted in response to receiving a deletion-allow message from each of the deletion objectors.

10. The computer-readable software framework of claim 9, at least a portion of which is configured to adhere to JCore distributed computing technology or Jini distributed computing technology.

11. The computer-readable software framework of claim 5, wherein
the type of reply message sent by each deletion objector is based on dependencies of the deletion objector on the selected resource objects; and wherein
the deletion objector is operable to determine the dependencies on the selected resource objects based on a resource object dependency database, the resource object dependency database storing dependencies of the deletion objector on resource objects maintained by the application.

12. The computer-readable framework of claim 11, wherein each of the dependencies stored in the resource object dependency database is one of an essential and a non-essential type of dependency.

13. The computer-readable software framework of claim 11, wherein the application includes a resource object database, the resource object dependency database comprising at least a subset of the resource object database.

14. The computer-readable software framework of claim 13, wherein the resource object dependency database is maintained within the deletion objector.

15. The computer-readable software framework of claim 1, wherein the application manages a storage area network (SAN), at least one of the value-add components performing a storage area management function for the application.

16. The computer-readable software framework of claim 1, wherein the application includes a resource object database, at least one of the value-add components performing a function for managing the resource object database.

17. A user interface (UI) component in a computer-readable medium, execution of which causes one or more processors to determine whether or not to delete a resource object from a resource object database maintained by an application, the UI component comprising:
a registration component to register one or more application components, which are interested in changes to the resource object database, as deletion objectors;
a user request component to receive a deletion request from a user, the deletion request identifying one or more resource objects in the resource object database selected by the user to be deleted; and
an agent object corresponding to each deletion objector, the agent object relaying the deletion request to the deletion objector and receiving reply messages sent by the deletion objector in response to the deletion request.

18. The computer-readable UI component of claim 17, further comprising:
a delete authorization component to determine whether or not the selected resource objects should be deleted based on the received reply messages, the delete authorization component classifying each received reply message as one of a deletion-prevent message, a user-warn message, and a deletion-allow message.

19. The computer-readable UI component of claim 18, wherein
the delete authorization component prevents deletion of the selected resource objects if at least one of the received reply messages is classified as a deletion-prevent message; and wherein
the delete authorization component permits deletion of the selected resource objects if the reply message received from each of the deletion objectors is classified as a deletion-allow message.

20. The computer-readable UI component of claim 19, wherein
the delete authorization component performs a warning function if none of the received reply messages are classified as deletion-prevent messages, and if at least one received reply message is classified as a user-warn message, and wherein
the delete authorization component performs the warning function by outputting each reply message, which is classified as a user-warn message, and prompting the user to respond to the output reply messages by either canceling or confirming the deletion request.

21. The computer-readable UI component of claim 20, wherein
the delete authorization component prevents deletion of the selected resource objects if the user responds to the output reply messages by canceling the deletion request, and wherein
the delete authorization component permits deletion of the selected resource objects if the user responds to the output reply messages by confirming the deletion request.

22. A method of determining whether or not to delete a resource object from an application executed on one or more processors, the application including a user interface (UI) component and one or more value-add components registered as deletion objectors, the method comprising:
inputting a deletion request via the UI component, the deletion request being a request to delete one or more selected resource objects;
relaying the deletion request from the UI component to the deletion objectors; and
sending a reply message from each of the deletion objectors to the UI component in response to the deletion request based on dependencies on the selected resource objects.

23. The method of claim 22, wherein the sending steps sends one of the following types of reply messages from each of the deletion objectors:
a deletion-prevent message indicating that the selected resource objects should not be deleted;
a user-warn message indicating at least one consequence of deleting the selected resource objects; and
a deletion-allow message permitting the selected resource objects to be deleted.

24. The method of claim 23, further comprising:
deleting the selected resource objects if the UI component receives a deletion-allow message from each of the deletion objectors; and
preventing execution of the deletion request if the UI component receives at least one deletion-prevent message from the deletion objectors.

25. The method of claim 24, further comprising:
performing a warning function if the none of the reply messages received by the UI component from the deletion objectors are deletion-prevent messages, the warning function including,
outputting each user-warn message received by the UI component from the deletion objectors, and
prompting the user to respond to the output user-warn messages by either canceling or confirming the deletion request; and
deleting the selected resource objects if the user responds to the output user-warn messages by confirming the deletion request.

26. An apparatus for determining whether or not to delete a resource object from a resource object database, the resource object database being maintained by an application executed on one or more processors, the apparatus comprising:
registration means for registering one or more value add components of the application as deletion objectors;
user interface (UI) means to input a deletion request to delete one or more selected resource objects from the resource object database;
relaying means for relaying the received deletion request to the deletion objectors;
receiving means for receiving a reply message from each of the deletion objectors in response to the deletion request; and
delete authorization means for determining whether or not to delete the selected resource objects based on the received reply messages.

27. The apparatus of claim 26, further comprising:
warning means for performing a warning function if none of the received reply messages are deletion-prevent messages, and if at least one received reply message is a user-warn message, wherein
the warning means performs the warning function by outputting each user-warn messages, and prompting the user to respond to the output user-warn messages by either confirming or canceling the deletion request.

28. The method of claim 27, wherein the delete authorization means includes,
means for causing the selected resource objects to be deleted if the reply message received from each of the deletion objectors is a deletion-allow message; and
means for causing the selected resource objects to be deleted if the warning function is performed, and if the user responds to the output user-warn messages by confirming the deletion request.
